(19) United States
(12) Patent Application Publication
(10) Pub. No.: US 2004/0216140 A1
(43) Pub. Date: Oct. 28, 2004

(54) Method and system for accessing system operations through an interface layer

(76) Inventor: Daniel K. Hiltgen, Los Gatos, CA (US)

Correspondence Address: KUDIRKA & JOBSE, LLP, ONE STATE STREET, SUITE 800, BOSTON, MA, 02109, US

(21) Appl. No.: 10/285,893

(22) Filed: Oct. 31, 2002

(51) Int. Cl. G06F 9/00

(52) U.S. Cl. 719/320

(57) ABSTRACT

A method and system for accessing system operations. Specifically, the present invention describes a method for accessing system administration operations that first comprises creating a shell interface layer. The shell interface layer comprises a plurality of standard routines for performing a plurality of system administration operations. The shell interface layer is supported within a scripting environment. Additionally, interfacing between the plurality of standard routines and a plurality of varying devices is provided. As such, a script that performs a standard routine that is written for a particular device is partially compatible with newer versions of the device. In particular, the script is able to recognize the presence of additional features to the standard routine available in the newer device.

### BACKGROUND OF THE INVENTION

1. Field of the Invention

Embodiments of the present invention relate to the field of data storage systems. More particularly, embodiments of the present invention relate generally accessing storage administration operations on an electronic device.

2. RELATED ART

Data storage systems increasingly are becoming larger due to advances in technology. As a result, the importance of system administration of these data storage systems is critical. In particular, automation of performing routine system administration tasks can increase the efficiency of a system administrator's role in maintaining a data storage system. However, custom scripts used to perform the automation of routine tasks of a current data storage system frequently are not transferable to newer versions of the same data storage system. Thus, requiring the creation of new custom scripts to perform the automation.

Prior Art FIG. 1 is a block diagram of a data storage system 100 illustrating the automation of performing routine system administration tasks on the system 100. Command line interface (CLI) tools 120 are provided for accessing the operating system 140 of the data storage system 100 and periphery hardware 150 that is associated with the data storage system 100.

The CLI tools 120 are used to call up routines stored in a library 130. The routines are used to perform a system administration task or operation on the operating system 140 or the hardware 150. Typically, the routines access or perform lower level storage administration operations.

Custom scripts 110 are created by a user of the data storage system 100. The custom scripts 110 are implemented to perform the routines and tasks associated with the various CLI tools 120. A custom script sends a request 115 for accessing underlying data and functionality of the data storage system 100. Output is returned to the custom scripts 110 in the form of a text response. The custom scripts 110 are able to parse the output text response 117, thus enabling access to the lower level system administration operations.

However, the interface to the library 130 through the CLI tools 120 is not generally publicly disclosed, requiring time on the system and experience to gain a familiarity with the CLI tools 120 and the format of their text responses 117. The custom scripts 110 are generated from the knowledge and experience of system administrators on a particular data storage device. Unfortunately, those custom scripts 110 are limited in their application to the particular data storage system 100 for which they were written.

In particular, previous interfaces to the library 130 suffered from arbitrary evolution between succeeding generations of the data storage system. Newer generations of data storage systems were not equally accessible by existing custom scripts 110. Knowing that the custom scripts 110 were fragile and particular to one data storage system, developers of new generations of data storage systems could be reluctant to change the output of CLI tools 120 (e.g., the text response 117) for fear of breaking existing custom shell scripts.

Unfortunately, changes to the CLI tools 120 are frequently necessary to enable new features of the new generation of the data storage system 100. For example, the new generation of data storage system 100 may contain hardware 160 to replace hardware 150 of the data storage system 100. Custom scripts 110 used for accessing CLI tools compatible with the previous generation of the data storage system 100 would now be incompatible with the newer generation of system 100 and would break upon implementation. At that point, automation of operations associated with the CLI tools would cease.

Since the interface to the new generation of data storage system 100 is private, this would require additional time on the system in order for the system administrator to learn the new output to the CLI tools 120 from hardware 160 included within the new generation of the data storage system 100. Thereafter, the system administrator could make changes to the custom scripts 110 to access the new output associated with the hardware 160 of the new generation of the data storage system 100.

### SUMMARY OF THE INVENTION

Embodiments of the present invention disclose a method and system for accessing system operations through an interface layer so that script programs will not fail when accessing system operations of newer generations of electronic devices. Another embodiment of the present invention discloses a method and system for a storage administration script tool.

Specifically, one embodiment of the present invention describes a method for accessing system administration operations within a storage device. The method begins by creating a shell interface layer. The shell interface layer comprises a plurality of standard routines for performing a plurality of system administration operations. The shell interface layer is supported within a scripting environment. The standard routines are provided to access the underlying data and functionality at a shell programmer level.

Additionally, interfacing between the plurality of standard routines and a plurality of varying devices is provided. A plurality of modules is provided for performing the interfacing of the plurality of standard routines. Each of the plurality of modules is adapted to run the plurality of standard routines on an associated device from the plurality of varying devices. As such, a custom script that calls and interprets a standard routine on a particular device is partially compatible with newer versions of the device.

In addition, because of the shell interface layer, the custom script is able to recognize the presence of additional features available in the newer device. This is possible even while operating under a shell interface layer that does not include the necessary updates to read the additional features. As such, custom scripts accessing the newer device will not crash; however, in order to take advantage of the additional features, the updates need to be incorporated into the shell interface layer.

### BRIEF DESCRIPTION OF THE DRAWINGS

PRIOR ART FIG. 1 is a block diagram of a data storage system illustrating how system operations are accessible through a command line interface.

FIG. 2 illustrates a block diagram of an exemplary data storage system that is capable of incorporating a shell interface layer for accessing system operations on a plurality of varying devices, in accordance with one embodiment of the present invention.

FIG. 3 is a block diagram of an exemplary data storage system illustrating the use of custom scripts to access the functionality of an application programming interface layer for accessing system operations in a plurality of varying electronic devices, in accordance with one embodiment of the present invention.

FIG. 4 is a block diagram of an exemplary data storage system illustrating the interrelationship between the application programming interface layer and a plug-in module for a particular electronic device, in accordance with one embodiment of the present invention.

FIG. 5 is a block diagram of an exemplary data storage system illustrating the ability of a custom script to access system operations of later generation electronic device that is incompatible with the implemented version of the application programming interface, in accordance with one embodiment of the present invention.

FIG. 6 is a flow chart illustrating steps in a method of accessing system operations of a data storage system, in accordance with one embodiment of the present invention.

FIG. 7 is a flow chart illustrating steps in a method of accessing system operations of a data storage system, in accordance with one embodiment of the present invention.

### DETAILED DESCRIPTION OF THE INVENTION

Reference will now be made in detail to the preferred embodiments of the present invention, a method and system for accessing system operations of an electronic device through an interface layer, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Notation and Nomenclature

Some portions of the detailed descriptions which follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “creating,” “interfacing,” “supporting,” “receiving,” “executing,” “presenting,” “parsing,” or the like, refer to the action and processes of a computer system, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

System Operations Access Through an Interface Layer

This disclosure describes a method and system for accessing system operations through an interface layer so that script programs will not fail when accessing system operations of newer generations of electronic devices. Another embodiment of the present invention discloses a method and system for a storage administration script tool.

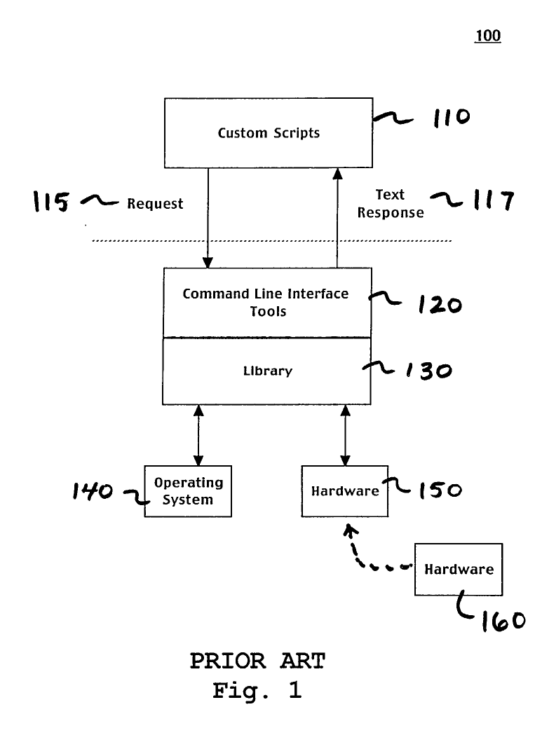

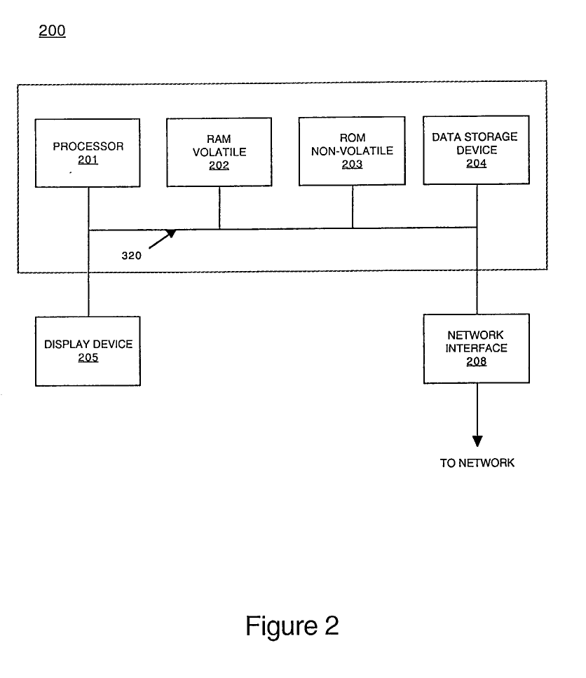

Referring now to FIG. 2, in accordance with one embodiment, the present invention is comprised of computer-readable and computer-executable instructions which reside, for example, in computer-readable media of a computer system, such as, computer system 200 of FIG. 2. Computer system 200 can include exemplary embedded components including an internal address/data bus 220 for communicating information, a central processor 201 coupled with the bus 220 for processing information and instructions, a volatile memory 202 (e.g., random access memory (RAM), static RAM dynamic RAM, etc.) coupled with the bus 220 for storing information and instructions for the central processor 201, and a non-volatile memory 203 (e.g., read only memory (ROM), programmable ROM, flash memory, EPROM, EEPROM, etc.) coupled to the bus 220 for storing static information and instructions for the processor 201.

With reference still to FIG. 2, a signal input/output (I/O) communication device 208 is coupled to bus 220 for providing a communication link between the computer system 200 and other electronic devices. As such, signal I/O device 208 enables the central processor unit 201 to communicate with or monitor other electronic systems that are coupled to or associated with the computer system 200, possibly through a network environment.

An output mechanism may be optionally provided in order to present information at a display 205 or print output for the electronic system 200. Similarly, input devices, such as, a keyboard (not shown) and a mouse (not shown) may be provided for the input of information to the electronic system 200. Electronic system 200 may also include various forms of data storage 204 for storing large amounts of information.

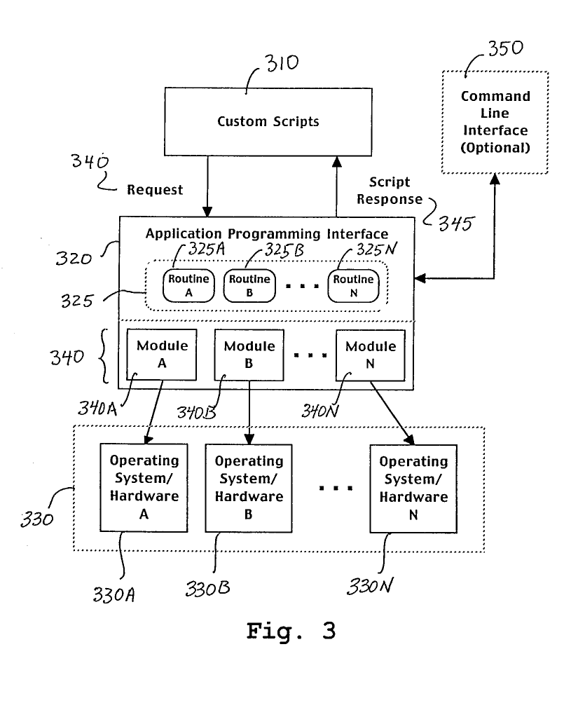

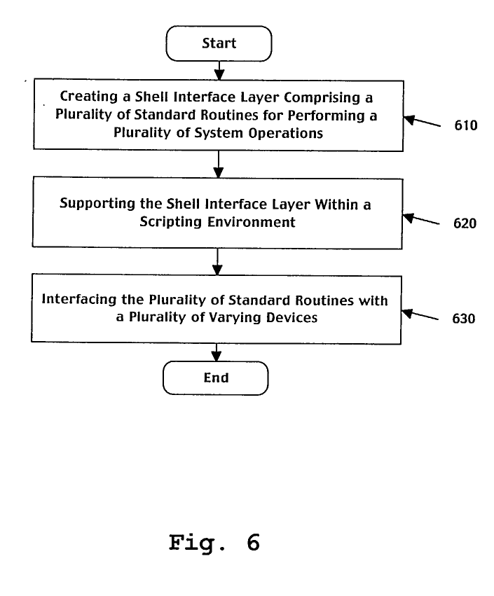

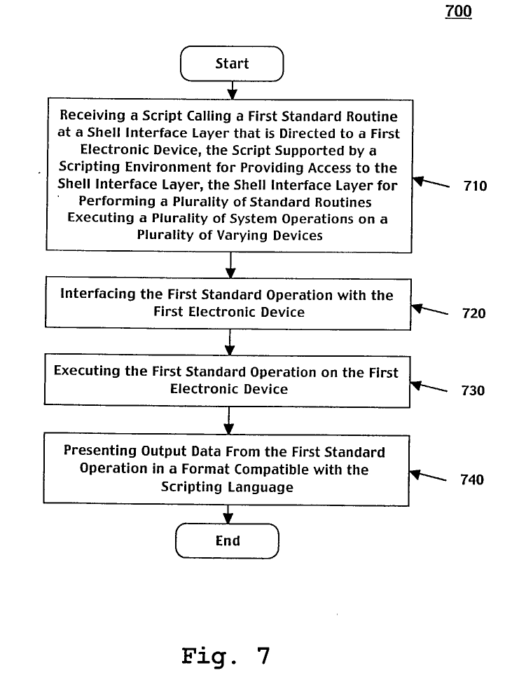

FIGS. 6 and 7, in combination with FIGS. 3, 4 and 5 illustrates flow charts 600 and 700 of steps for a method of accessing system operations through a script interface layer, in accordance with embodiments of the present invention.

Referring now to FIG. 6, in step 610 of flow chart 600, a shell interface layer that is a separate and additional software layer is created to access system operations of electronic devices, such as, data storage systems, in one embodiment of the present invention. The shell interface layer comprises a plurality of standard routines for performing a plurality of system operations. These built-in standard routines are provided to access the underlying data and functionality of the data storage system at the shell programmer level. In another embodiment, the shell interface layer is comprised of application programming interface (API) programs for accessing the underlying data and functionality of the data storage system.

Typically, the shell interface layer in combination with the plurality of standard routines provides access by a user (e.g., system administrator) to configure, monitor, update, and/or modify the data storage system. For example, a list of functions provided by the plurality of standard routines that is less than complete is herein provided for illustration only, as follows: discover all storage devices, power off storage device, get capacity of a storage device, find path to storage, download firmware, etc.

In one embodiment, the plurality of standard routines are comprised of low-level system operations to provide a user friendly interface that functions effectively within a shell environment. As such, the shell interface layer is capable of interfacing with a plurality of varying devices because of the restriction to low-level system operations within the plurality of standard routines.

In step 620, the present embodiment supports the shell interface layer 320 within a scripting environment. As such, the standard routines are accessed through scripts supported by the scripting environment instead of command line interface (CLI) tools. Accordingly, communication into and out from the shell interface layer is in the format of a scripting language supported by the scripting environment.

In one embodiment, the scripting environment is supported by the Korn shell (also known by the abbreviation, “ksh”). The Korn shell provides a mechanism to dynamically link new built-in routines to the shell interface layer 320 at run time. New sets of built-in routines could be developed that are accessed through a library by using ksh scripts. Since the ksh language is commonly understood by present day system administrators, a scripting interface could be provided using pre-developed ksh scripts to access system operations through the shell interface layer 320.

In another embodiment, the scripting environment is supported by any of the commonly known scripting languages used by system administrators, e.g., Bourne Shell, etc., and their derivatives. In still another embodiment, the scripting environment is supported by the Practical Extraction and Report Language (Perl) language. Also, the scripting environment could be newly developed, and based on any of the previously mentioned shells or languages. In particular, developing a new language based on the Bourne Shell would allow additional control over the system operations of a data storage system, with minimal costs of supporting the parser, and interpretation of standard shell built-in routines.

In step 630 of flow chart 600, the present embodiment interfaces the plurality of standard routines with a plurality of varying devices. The details of the interfacing as implemented with plug-in modules, in accordance with one embodiment, will be provided below.

FIG. 3 is a block diagram illustrating the implementation of the shell interface layer 320 for accessing system operations of various electronic devices associated with a data storage system, in accordance with one embodiment of the present invention. The shell interface layer 320 in one embodiment is an application programming interface (API) that comprises a plurality of routines 325 for directing the performance of system operations within operating systems or peripheral hardware associated with electronic devices, e.g., a data storage system.

For example, the plurality of routines 325 comprises routine A 325A, routine B 325B, on up to routine N 325N. As discussed previously, the routines are provided to access the underlying data and functionality of a data storage system, such as, discover all storage devices, power off storage device, get capacity of a storage device, find path to storage, download firmware, etc. The plurality of routines are designed to be programmatically consistent between the plurality of various devices 330.

The plurality of various devices 330 can be distinct and independent devices from each other. Also the various devices can be newer generations of a particular device, or older legacy generations of the particular device. All are fully supportable by the shell interface layer 320 with proper interfacing.

In one embodiment, the shell interface layer 320 provides access into the primitive environment of the data storage system without parsing output text from the CLI tools as implemented in the CLI layer. As such, access to the system operations of the data storage system is provided directly at the shell programmer level, as implemented by the plurality of routines 325. Responses to the routines as implemented by the shell interface layer 320 is formatted in the scripting language supported by the scripting environment.

A plurality of plug-in modules 340 are electrically coupled to the shell interface layer 320. For example, plug-in module A 340A is coupled with the shell interface layer 320, plug-in module B 340B is coupled with the shell interface layer 320, on up to plug-in module N 340N that is coupled with the shell interface layer 320.

The plurality of plug-in modules 345 modules provide for further interfacing between the plurality of routines 325 for running system operations on a plurality of varying devices 330, in one embodiment. As such, the plug-in modules 345 provide for interfacing an implemented version of the shell interface layer 320, and the plurality of standard routines 325, with each of the plurality of varying devices 330. More specifically, each of the plurality of modules 340 is adapted to run the plurality of routines 325 on an associated device from the plurality of varying devices 330. By plugging in the correct module, the shell interface layer 320, and the plurality of routines 325 contained therein, can support any number of electronic devices.

For example, module A 340A coupled to the shell interface layer 320 provides for performing the system operations on the operating system or periphery hardware (OS/H)-A 330A. Accordingly, module B 340B coupled to the shell interface layer 320 provides for performing the system operations on OS/H-B 330B. Also, module N 340N coupled to the shell interface layer 320 provides for performing the system operations on the OS/H-N 330N.

In still another embodiment, the shell interface layer 320 can be optionally accessed through a command line interface (CLI) 350 interface. As such, CLI tools can be developed specifically to access the plurality of routines 325 located at the shell interface layer 320.

In other embodiments, each of the blocks contained in FIG. 3 associated with a data storage system substantially comply with small computer system interface (SCSI) protocols for communication purposes. In other embodiments, other protocols, such as, Fibre Channel (FC), Internet Protocol (IP), Infiniband, etc., are possible.

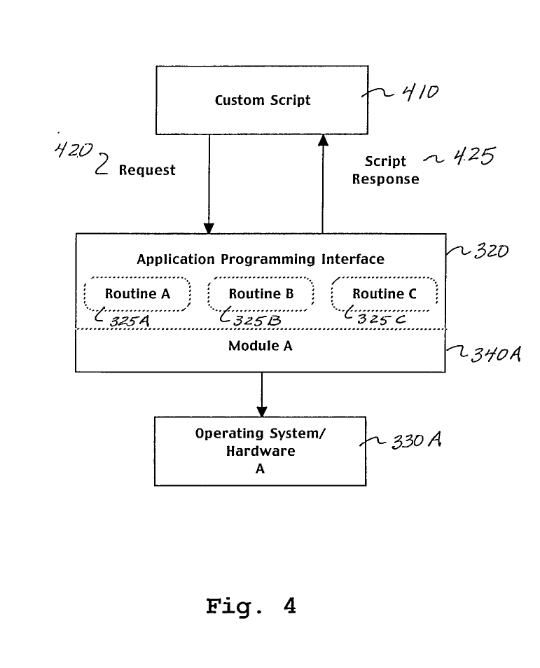

Referring now to FIG. 4, a block diagram is shown illustrating the interfacing between the shell interface layer 320 that is an API layer with the operating system or hardware (OS/H) of an electronic device 330A, e.g., a data storage device, in accordance with one embodiment of the present invention.

Custom scripts are used to access the routines that are applicable to the OS/H 330A. For illustration only, routine A 325A, routine B 325B, and routine C 325C are used to access the system operations associated with OS/H 330A. For other OS/Hs (e.g., 330B, etc.) other combinations of routines may be used to access their system operations.

In particular, a custom script 410 can be used to access one or more of the routines A, B, or C, in any combination and any multiples of combinations for automation purposes. In one implementation, a standard routine (e.g., routine B 325B) is called by the custom script 410. As such, the request 420 is sent to the shell interface layer 320 for the performance of routine B 325B. Routine B 325B is used to access particular system operations in the OS/H-A 330A.

Module A 340A provides for further interfacing between the shell interface layer 320 and the OS/H-A 330A. While the routines (e.g., routines A-C 325A-C) are generally applicable to any number of devices (e.g., the plurality of varying devices 330), the particular functionality of each of the routines as adapted for a specific device (e.g., OS/H-A 330A) can be found in module A 340A. In addition, the programmatic details of the routine B 325B can be handled in either module A 340A, the shell interface layer 320, or any shared combination between the two.

A script response 425 is provided in the format of the scripting language supported by the scripting environment used to access the shell interface layer 320. As such, the details of routine B 325B are able to parse the output as provided by the OS/H-A 330A and format the output in the previously mentioned scripting language.

In one embodiment, because the response is returned in the format of scripting language supported by the scripting environment used to access the shell interface layer 320, the custom script 410 will not crash when implemented on newer versions of the OS/H-A 330A. A newer version may have additional features provided by its system operations as called for in routine B 325B.

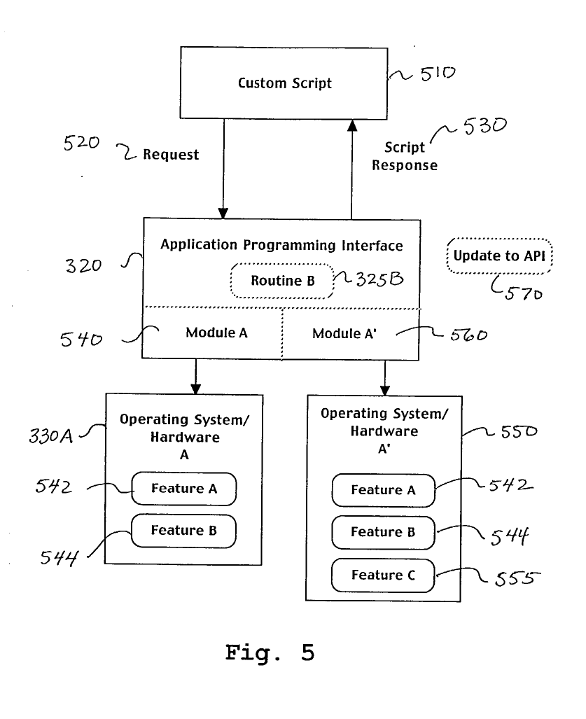

Referring now to FIG. 5, a block diagram is shown illustrating the ability of the shell interface layer 320, that is an API layer, to interface with various versions of an operating system or periphery hardware associated with a data storage device, in accordance with one embodiment of the present invention.

The present embodiment accesses the API 320 through a custom script 510 to perform a standard routine B 325B. The custom script 510 calls the routine B 325B through a request 520 that is written in the scripting language supported by the scripting environment used to access the API layer 320.

The API layer 320 is able to support a variety of devices, as long as the appropriate interfaces have been developed and placed in a module for interfacing between the routines in the API layer 320 and the associated device. In the present embodiment, module A 540 is coupled to the API layer to provide access to the data and functionality of the system operations of the OS/H-A 330A. Also, module A′ 550 is coupled to the API layer 320 to provide access to the data and functionality of the system operations of the OS/H-A′ 550.

The OS/H-A′ 550 is an updated version of the OS/H-A 330A. Frequently, the OS/H-A′ 550 may contain additional features in support of routine B 325B. In particular, both features A and B, 542 and 544, respectively, are provided in response to routine B 325B in the implemented version of the shell interface layer 320. Feature C 555 on the other hand is provided only by OS/H-A′ 550.

In other embodiments OS/H-A′ 550 is a legacy version of the OS/H-A 330A. The legacy version may include various features that are incompatible with the implemented version of the API layer 320. In still other embodiments, OS/H-A′ 550 is a totally different device unrelated to OS/H-A 330A. However, the script 510 is still able to access the functionality contained in the system operations of the device through the routine B 325B. The unrelated device may also contain features that are incompatible with the implemented version of the API layer 320.

For a request that is directed to OS/H-A 330A, the custom script 510 that is receiving the script response 530 in general calls the functionality of routine B. Device OS/H-A 330A will return feature A 542 and feature B 544 in response to routine B 325B. Because the implemented version of the shell interface layer 320 is compatible with the features provided by OS/H-A 330A, a script response 530 will contain both feature A 542 and feature B 544.

On the other hand, for a request that is directed to OS/H-A′ 550, if the implemented version of the shell interface layer 320 cannot support feature C 555, then feature C will not be provided as output in the script response 530.

At first, device OS/H-A′ 550 will return features A-C 542, 544, and 555, respectively to the API layer 320. Ordinarily, the custom script 510, without the shell interface layer 320, would be unable to parse the output from the OS/H-A′ 550 and determine that feature C is new and unsupportable, and would break upon receiving feature C 555. However, with the benefit of the shell interface layer 320, although the implemented version of the shell interface layer 320 cannot support feature C, the shell interface layer 320 is able to parse the output to the routine B 325B and understand that feature C is incompatible with the implemented version of the shell interface layer 320.

As such, feature C 555 will be dropped from the script response 530 that is returned to the custom script 510. In addition, optionally, the shell interface layer 520 can provide in the script response 530 notification that new features are available within OS/H-A′ 550 that are unsupportable without updates to the shell interface layer. These updates, as shown in the API update 570, can be implemented directly into the API layer 320, or alternatively, provided in module A′ 550, depending on the particular application.

In another embodiment, other versions of the shell interface layer 320 exist. These other versions may include updates (e.g., API update 570) that provide the ability to access new features included within new generations of operating systems and periphery hardware associated with a data storage system. These other versions contain compatible versions of the plurality of standard routines (e.g., 325 in FIG. 3). As such, a script performing a first standard routine on a OS/H can perform a compatible version of the first standard routine, using another version of the shell interface layer 320, on the same first device. A response would be provided in both cases, and would be nearly identical if all the features were fully supported by both versions of the shell interface layer. The script would follow a format of a scripting language supported by the scripting environment.

FIG. 7 illustrate a flow chart 700 of steps for a method of accessing system operations through a shell interface layer, in accordance with one embodiment of the present invention. In step 710, the present embodiment receives a script that is calling a standard routine located at a shell interface layer. The script is directed to an electronic device (e.g., an operating system or periphery hardware (OS/H) associated with a data storage system).

As discussed previously, the script is supported by a scripting environment for providing access to the shell interface layer. The shell interface layer includes a plurality of standard routines for performing a plurality of system operations on the OS/H. The plurality of system operations is performed on a plurality of varying devices through the shell interface layer.

In step 720, the present embodiment interfaces the standard operation with the electronic device. As mentioned previously, a module that is designed for the electronic device is adapted to run the plurality of standard routines in the shell interface layer on the aforementioned electronic device.

In step 730, the present embodiment executes the standard routine on the electronic device. As such, system operations associated with the standard routine are executed on the electronic device and returned to the shell interface layer.

The shell interface layer is able to parse output data from the standard routine and determine which results are supported by the implemented version of the shell interface layer, and which results are not supported by the implemented version of the shell interface layer.

The shell interface layer is able to present a response to the requested routine in a format compatible with a scripting language that is supported by the scripting environment. The response presents only the results that are supported by the implemented version of the shell interface layer. The shell interface layer is able to optionally notify the presence of those results that are incompatible or unsupported by the implemented version of the shell interface layer without crashing the script that originally requested the standard routine.

While the methods of embodiments illustrated in flow charts 600 and 700 show specific sequences and quantity of steps, the present invention is suitable to alternative embodiments. For example, not all the steps provided for in the methods are required for the present invention. Furthermore, additional steps can be added to the steps presented in the present embodiment. Likewise, the sequences of steps can be modified depending upon the application.

Embodiments of the present invention, accessing system operations of a data storage system through an interface layer, is thus described. While the present invention has been described in particular embodiments, it should be appreciated that the present invention should not be construed as limited by such embodiments, but rather construed according to the below claims.

What is claimed is:

1. A method of system access comprising:
creating a shell interface layer comprising a plurality of standard routines for performing a plurality of system operations;
supporting said shell interface layer within a scripting environment; and
interfacing said plurality of standard routines with a plurality of distinct devices.

2. The method of claim 1, further comprising:
executing a first standard routine to be performed on a first distinct device by a script following a format of a scripting language supported by said scripting environment.

3. The method of claim 1, wherein said interfacing further comprises:
interfacing an implemented version of said shell interface layer and said plurality of standard routines with each of said plurality of distinct devices.

4. The method of claim 1, further comprising:
performing said interfacing of said plurality of standard routines using a plurality of modules, each of said plurality of modules adapted to execute said plurality of standard routines on an associated device from said plurality of distinct devices.

5. The method of claim 1, wherein compatible versions of said plurality of standard routines are included in other versions of said shell interface layer, such that a script performing a first standard routine on a first device can perform a compatible version of said first standard routine on said first device, said script following a format of a scripting language supported by said scripting environment.

6. The method of claim 5, wherein features available to said plurality of standard routines that are not supported by an implemented version of said shell interface layer are exposed to said script while allowing said script to execute.

7. The method of claim 1, wherein said plurality of standard routines comprises a plurality of application programming interfaces (APIs).

8. The method of claim 1, wherein said plurality of standard routines provide access to underlying data and functionality for each of said plurality of distinct devices.

9. A method of system access comprising:
receiving a script for executing a first standard routine at a shell interface layer, said script directed to a first device, said script supported by a scripting environment for providing access to said shell interface layer, said shell interface layer for performing a plurality of standard routines that perform a plurality of system operations, including said first standard routine, on a plurality of varying devices;
interfacing said first standard routine with said first device;
executing said first standard routine on said first device; and
presenting output data from said first standard routine in a format compatible with said scripting environment.

10. The method of claim 9, further comprising:
parsing output data from said first standard routine, said output data comprising results compatible with an implemented version of said shell interface layer; and
presenting said first results in a scripting language supported by said scripting environment.

11. The method of claim 9, further comprising:
parsing output data from said first standard operation, said output data comprising results incompatible with an implemented version of said shell interface layer; and
exposing the presence of said results without crashing said script.

12. The method of claim 9, wherein at least one of said plurality of varying devices is a storage device.

13. The method of claim 9, wherein said plurality of system operations are low-level system administration operations.

14. The method of claim 9, further comprising:
accessing to said plurality of standard routines through a plurality of command line interface (CLI) tools.

15. A computer implemented script tool comprising:
a shell interface layer comprising a plurality of standard routines for performing a plurality of system operations;
a scripting environment for accessing said shell interface layer; and
a plurality of modules for performing interfacing of said plurality of standard routines with a plurality of varying devices, each of said plurality of modules adapted to run said plurality of standard routines on an associated device from said plurality of varying devices.

16. The script tool as described in claim 15, wherein said scripting environment is substantially supported by one of a group consisting of:
Bourne shell;
Perl shell; and
Korn shell.

17. The script tool as described in claim 15, wherein at least one of said plurality of various devices is an operating system of a storage device.

18. The script tool as described in claim 15, wherein at least one of said plurality of various devices is hardware associated with a storage device.

19. The script tool as described in claim 15, further comprising:
a plurality of command line interface tools for providing access to said plurality of standard routines.

20. The script tool as described in claim 15, wherein
a script calling a first standard routine to be performed on a first device follows a format of a scripting language supported by said scripting environment.

21. The script tool as described in claim 15, further comprising:
compatible versions of said plurality of standard routines included within other versions of said shell interface layer, such that a script performing a first standard routine on a first device can perform a compatible version of said first standard routine on a second device, said script following a format of a scripting language supported by said scripting environment.

22. A computer system comprising:
a processor; and
a computer readable memory coupled to said processor and containing program instructions that, when executed, implement a method of system access comprising:
creating a shell interface layer comprising a plurality of standard routines for performing a plurality of system operations;
supporting said shell interface layer within a scripting environment; and
interfacing said plurality of standard routines with a plurality of distinct devices.

23. The computer system of claim 22, wherein said method further comprises:
executing a first standard routine to be performed on a first distinct device by a script following a format of a scripting language supported by said scripting environment.

24. The computer system of claim 22, wherein said interfacing in said method further comprises:
interfacing an implemented version of said shell interface layer and said plurality of standard routines with each of said plurality of distinct devices.

25. The computer system of claim 22, wherein said method further comprises:
performing said interfacing of said plurality of standard routines using a plurality of modules, each of said plurality of modules adapted to execute said plurality of standard routines on an associated device from said plurality of distinct devices.

26. The computer system of claim 22, wherein compatible versions of said plurality of standard routines are included in other versions of said shell interface layer, such that a script performing a first standard routine on a first device can perform a compatible version of said first standard routine on said first device, said script following a format of a scripting language supported by said scripting environment.

27. The computer system of claim 26, wherein features available to said plurality of standard routines that are not supported by an implemented version of said shell interface layer are exposed to said script while allowing said script to execute.

28. The computer system of claim 22, wherein said plurality of standard routines comprises a plurality of application programming interfaces (APIs).

29. The computer system of claim 22, wherein said plurality of standard routines provide access to underlying data and functionality for each of said plurality of distinct devices.
